(19) United States
(12) Patent Application Publication
(10) Pub. No.: US 2021/0350464 A1
(43) Pub. Date: Nov. 11, 2021

(54) QUANTITATIVE CUSTOMER ANALYSIS SYSTEM AND METHOD

(71) Applicant: The Bank of Nova Scotia, Toronto (CA)

(72) Inventors: Alberto Ivan Mendoza MARTINEZ, Toronto (CA); Adriana Valderrama BARAHONA, Toronto (CA); Stephan Hayden BARROW, Toronto (CA)

(21) Appl. No.: 17/317,016

(22) Filed: May 11, 2021

Related U.S. Application Data
(60) Provisional application No. 63/022,838, filed on May 11, 2020.

(51) Int. Cl. G06Q 40/06; G06Q 40/08; G06Q 40/02; G06Q 40/00; G06N 20/00; G06N 5/04

(52) U.S. Cl. CPC G06Q 40/06; G06Q 40/08; G06N 5/04; G06Q 40/12; G06N 20/00; G06Q 40/025

(57) ABSTRACT

The disclosure herein relates generally to quantitative customer analysis including segmenting a plurality of customers into a plurality of cohorts based on a performance driver indicative of future customer performance, wherein a first cohort includes a first customer; generating a plurality of cohort forecasts corresponding to the plurality of cohorts, each cohort forecast based on the performance driver of each customer belonging to a corresponding cohort, wherein the plurality of cohort forecasts are generated for a remaining lifetime of the customer; and, calculating a customer lifetime value (CLV) metric for the first customer based on the plurality of cohort forecasts and a set of transition probabilities indicative of a likelihood that the first customer remains in the first cohort, or transitions to a different cohort.

### CROSS REFERENCE TO RELATED APPLICATIONS

This application claims the benefit of priority of U.S. Provisional Patent Application No. 63/022,838 filed May 11, 2020, which is hereby incorporated by reference.

### FIELD

The present disclosure relates generally to forecasting future performance of customers and even more particularly to forecasting financial performance of term products and non-term product held by customers.

### BACKGROUND

Modern commercial banks may leverage a vast array of consumer data to service their customers. Such data may improve predictions for how customers' needs and usage may evolve, and accordingly, help commercial banks identify how to better serve their customers. One customer centric approach involves predicting current customer needs based on historical customer data, enabling commercial banks to tailor offerings and terms to suit current customer demand, thereby enhancing customer satisfaction.

It remains desirable to develop further improvements and advancements in forecasting future performance, to overcome shortcomings of known techniques, and to provide additional advantages.

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

### BRIEF DESCRIPTION OF THE DRAWINGS

Embodiments will now be described, by way of example only, with reference to the attached Figures.

FIGS. 1A and 1B are flowcharts of a quantitative customer analysis system and method for determining a customer lifetime value in accordance with an embodiment as disclosed herein.

FIG. 2 is a diagram based on FIGS. 1A and 1B of a quantitative customer analysis system for determining a customer lifetime value in accordance with an embodiment as disclosed herein.

FIG. 3A is a diagram for segmenting a plurality of customers into customer cohorts, including determining corresponding performance forecasts for each cohort, in accordance with an embodiment as disclosed herein.

FIG. 3B is a diagram for a transition probability matrix in accordance with an embodiment as disclosed herein, for the customer cohorts illustrated in FIG. 3A. The transition probability matrix illustrates a set of probabilities, for each year in a remaining lifetime of a financial product, for a customer to remain in a given customer cohort, or transition to a different customer cohort.

FIG. 3C is a diagram for determining a customer lifetime value profitability metric based on FIGS. 3A and 3B, in accordance with an embodiment as disclosed herein.

FIG. 4 is a flowchart of a quantitative customer analysis system for determining a customer lifetime value for a term product in accordance with an embodiment as disclosed herein.

FIG. 5A illustrates a timeline for quantifying the customer lifetime value of a term product in accordance with the embodiment illustrated in FIG. 4.

FIG. 5B illustrates a flow chart for determining a first future performance for a remaining term, in accordance with the timeline illustrated in FIG. 5A.

FIG. 5C illustrates a flow chart for determining a second future performance for an expected lifetime in accordance with the timeline illustrated in FIG. 5A.

FIG. 6 is a diagram for segmenting a plurality of customers into customer cohorts based on amortization terms in accordance with determining the second future performance illustrated in FIGS. 5A and 5C. The diagram further illustrates a corresponding amortization schedule for each cohort, generated based on the customers in each cohort.

Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompassed by the corresponding description.

### DETAILED DESCRIPTION

The following are examples of a quantitative customer analysis system and method as disclosed herein.

In an aspect, a computer-implemented method for determining a customer lifetime value (CLV) of a financial product held by a customer is disclosed, the method including retrieving, from a memory, an attrition driver and a performance driver; determining, using a processor, a remaining lifetime of the financial product, based on the attrition driver; determining, using the processor, a plurality of customer cohorts for segmenting a plurality of customers based on the performance driver; determining, using the processor, a plurality of cohort performance drivers correspondingly based on a value of the performance driver for each cohort of the plurality of customer cohorts; generating, using the processor, a plurality of risk adjusted forecasts of the financial product over the remaining lifetime of the financial product, correspondingly based on the plurality of cohort performance drivers; retrieving, from the memory, a transition probability matrix comprising probabilities, over the remaining lifetime of the financial product, for remaining in a current customer cohort or transitioning to a different customer cohort; determining, using the processor, the CLV over the remaining lifetime of the financial product, the CLV based on a customer current value for the financial product and a weighted sum of the plurality of risk adjusted forecasts and the transition probability matrix.

In an embodiment, the computer-implemented method further includes generating, using the processor, a plurality of CLV cohorts, each CLV cohort grouped based on current value and future value, and assigning, using the processor, the customer to one of the plurality of CLV cohorts based on the customer current value and the CLV.

In an embodiment, the plurality of CLV cohorts includes a first CLV cohort wherein the current performance is high and the future performance is high; a second CLV cohort wherein the current performance is low and the future performance is high; a third CLV cohort wherein the current performance is high and the future performance is low, and a fourth CLV cohort wherein the current performance is low and the future performance is low.

In an embodiment, the computer-implemented method further includes generating the set of performance drivers using machine learning on a plurality of data from a plurality of customers having a history with the financial product.

In an embodiment, the risk adjusted forecast is adjusted based on at least one of a renewal likelihood, and a breakage likelihood. In an embodiment, the risk adjusted forecast is adjusted based on expected credit loss. In an embodiment, the expected credit loss is based on external accounting data. In an embodiment, the external accounting data is based on the International Financial Reporting Standard 9 (IFRS9).

In an embodiment, the computer-implemented method further includes generating an attrition curve based on the attrition driver, the attrition curve for determining the remaining lifetime of the financial product.

In an embodiment, the financial product is at least one of a credit card, a line of credit, or a mortgage. In an embodiment, the financial product is a credit card and the set of performance drivers includes a credit score and a delinquency rate. In an embodiment, the financial product is a fixed term financial product and the remaining lifetime is a remaining term of the fixed-term financial product.

In an embodiment, the computer-implemented method further includes generating the transition probability matrix using a Markov model.

In an aspect, a computer-implemented method for determining a customer lifetime value (CLV) for a customer is disclosed, the method including segmenting a plurality of customers into a plurality of cohorts based on a performance driver indicative of future customer performance, wherein a first cohort includes the customer; generating a plurality of cohort forecasts corresponding to the plurality of cohorts, each cohort forecast based on the performance driver of each customer belonging to a corresponding cohort, wherein the plurality of cohort forecasts are generated for a remaining lifetime of the customer; and, calculating the CLV metric based on the plurality of cohort forecasts and a set of transition probabilities indicative of a likelihood that the customer remains in the first cohort, or transitions to a different cohort.

In an embodiment, the computer-implemented method further includes segmenting the plurality of customers into the plurality of cohorts based on a similarity metric between the performance driver of each of the plurality of customers. In an embodiment, the similarity metric is a Euclidean distance.

In an embodiment, the performance driver of each customer of a corresponding cohort is within three-standard deviations of an average value of the performance driver for the corresponding cohort.

In an embodiment, the remaining lifetime of the customer is based on a remaining lifetime of a cohort. In an embodiment, the cohort is the first cohort. In an embodiment, the remaining lifetime of the cohort is based on an attrition driver for the cohort. In an embodiment, the attrition driver is at least one of a risk score, a usage rate, a default rate, and a delinquency rate. In an embodiment, the attrition driver is a customer exit rate based on historical customer data for the cohort. In an embodiment, the remaining lifetime is indicative of a point in time wherein 50% of or less of the customers originally in the cohort are no longer expected to remain in one of the plurality of cohorts.

In an embodiment, the computer-implemented method further includes adjusting the cohort forecasts based on a corresponding cohort risk metric. In an embodiment, the cohort risk metric is indicative of negative future customer performance.

In an embodiment, the computer-implemented method further includes generating the set of transition probabilities based on historical transition data indicative of migration patterns between the plurality of cohorts. In an embodiment, generating the set of transition probabilities includes inputting the historical transition data to a Markov model.

In an embodiment, the CLV metric is a profitability metric for a financial product held by the customer. In an embodiment, the financial product is a non-term financial product. In an embodiment, the performance driver is at least one of a balance with a banking institution, an interest rate of the financial product, and a customer income. In an embodiment, the computer-implemented method further includes generating the CLV metric in present day dollars based on a discount rate. In an embodiment, the computer-implemented method further includes generating a CLV profitability metric for a plurality of financial products.

The quantitative customer analysis system and method disclosed herein generally relates to segmenting a plurality of customers into customer cohorts, for determining a customer lifetime value of a customer, based on a current performance and a future performance of the customer cohorts, including adjusting the future performance based on future cohort behaviour. The customer lifetime value may be leveraged to identify future customer needs and thereby develop a customer specific strategy for making future decisions. Financial products generally include term and non-term products and their future performance may be determined using a risk adjusted forecast, generated over a remaining lifetime of the financial product held by the cohort. The remaining lifetime of the financial product may be determined for example using attrition models and/or other survival and decay models, generated based on attrition drivers. The future performance is adjusted based on future cohort behaviour which generally relates to the probability of a customer remaining in one customer cohort, or transitioning to another. Customer cohorts may be classified based on the performance drivers used to generate the corresponding risk adjusted forecast. A customer lifetime value for a given financial product may be generated based on a weighted sum of the risk adjusted forecast for each customer cohort. A customer lifetime value may be further generated for each financial product held by the customer, to generate a customer lifetime value across a plurality of financial products held by the customer. In this manner, a commercial bank may utilize the customer lifetime value to better identify future customer needs on the basis of one or more financial products currently held by the customer.

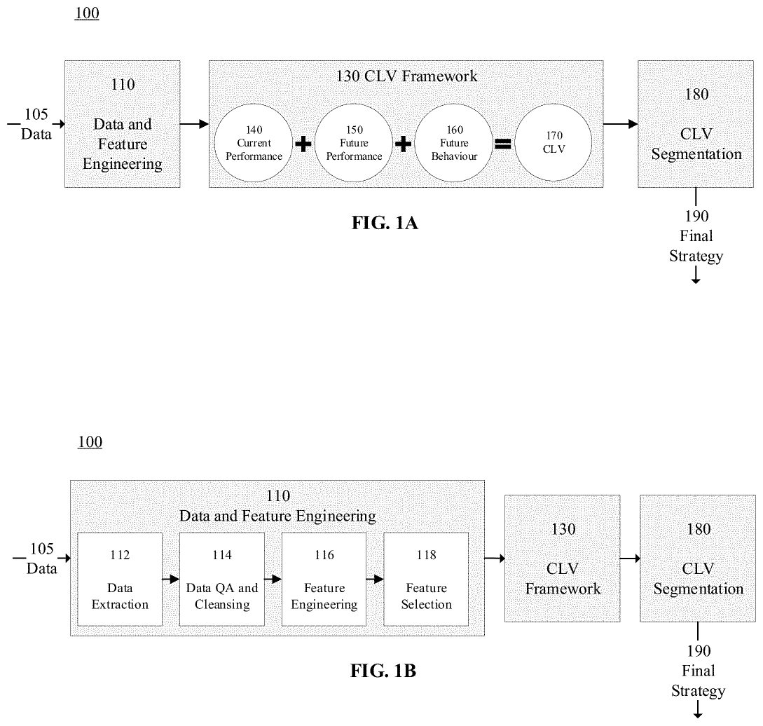

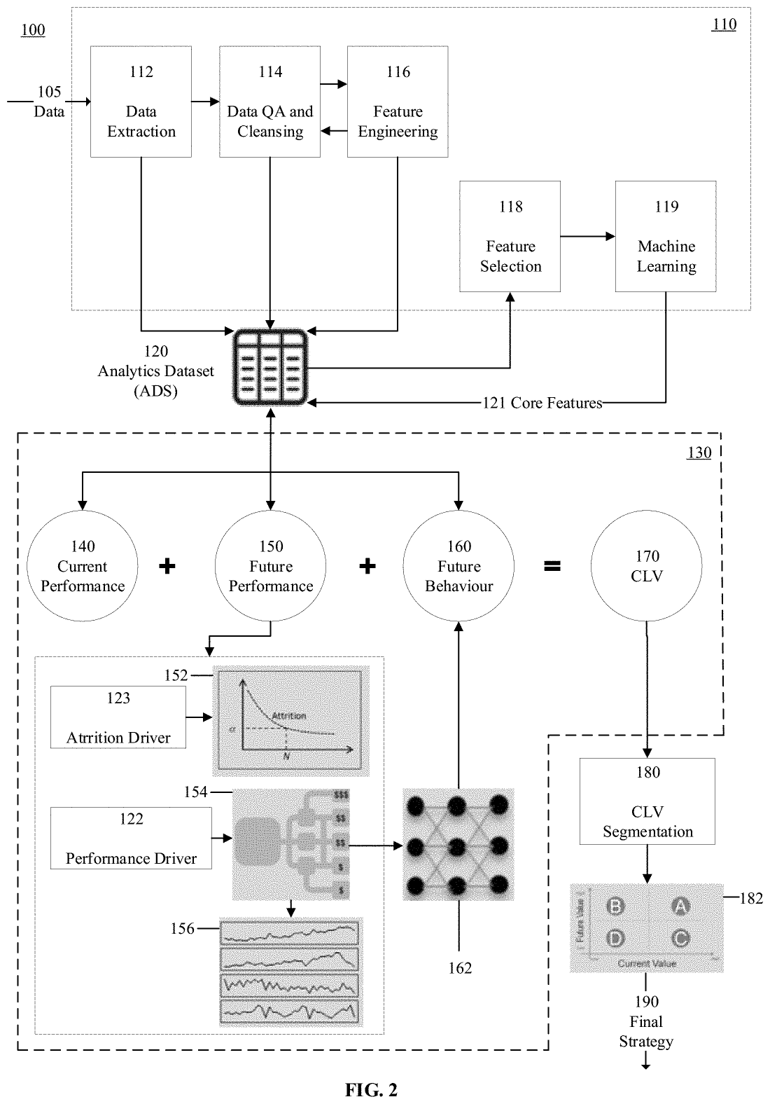

FIGS. 1A, 1B, and 2 are illustrative embodiments of a quantitative customer analysis system and method 100 as disclosed herein. The system and method 100 generally involve processing data 105 through steps of data and feature engineering 110, the output of which drives a customer lifetime value (CLV) framework 130 for generating a CLV 170 for input to CLV segmentation 180, which drives a final strategy 190. In an embodiment a discount rate is applied to estimate the CLV metric 170 in present day value.

As particularly depicted in the illustrative embodiment of FIG. 2, the outputs from the step of data and featuring engineering 110 may build an analytics dataset 120, used to drive the feature selection 118 and CLV framework 130. Data 105 may relate to a wide variety of metrics for a plurality of customers including, but not limited to credit information, banking information, biographical information, administrative information, payment history, market information, and digital information. Python, R, statistical analysis software (SAS), SQL, and other modeling technologies known in the art may be used for conducting steps of data and featuring engineering 110, generating a CLV metric 170, and conducting steps of CLV segmentation 180.

Data and feature engineering 110 may include a number of steps, such as data extraction 112, data quality assurance (QA) and cleansing 114, feature engineering 116, and feature selection 118. In an embodiment, data and feature engineering 110 may first include the step of data extraction 112 from a set of data 105. Data 105 may be stored in and retrieved from a number of sources including, but not limited to, local or remote databases, enterprise servers, cloud servers, an SQL server, or combinations thereof. The step of data extraction 112 may further include validating data 105, including validating layout and type. In an embodiment, extracted data may input to the analytics dataset (ADS) 120 and/or input to the step of data QA and cleansing 114. The step of data QA and cleansing 114 generally relates to transforming data for building the analytics dataset 120, and may include, but is no limited to, steps of data quality assurance, data cleansing, data transformations, imputing missing data, trimming outliers, and factor level reduction. In an embodiment, the output from the step of data QA and cleansing 114 may input to the analytics dataset 120 and/or input to the step of feature engineering 116. The step of feature engineering 116 generally relates to generating additional relevant data. For example, generating time series data relevant to determining future performance of a financial product held by a customer, or for example, generating data relevant to machine learning models. The output of the step of feature engineering 116 may include, but is not limited to, statistical data (minimums, maximums, mean, medium, standard deviations, slope, etc.), binning, recency frequency monetary (RFM) value, and time series data. The output of the step of feature engineering 116 may input to any one or more of the analytics dataset 120, the step of data QA and cleansing 114, and the step of feature selection 118. In an embodiment, the steps of data QA and cleansing 114 and feature engineering 116 may repeat for several iterations.

The step of feature engineering 118 receives a collection of data, such as an analytics dataset 120, and selects a set of core features 121 relevant to target variables that drive the customer lifetime value. For example, core features 122 may include performance drivers 122 for determining a future performance of the financial product held by the customer, and attrition drivers 123 for determining a remaining lifetime of the financial product held by the customer. Accordingly, the performance drivers 122 for determining a customer lifetime value profitability metric may relate to metrics for, including not limited to, determining future profits, future losses, and future losses based on IFRS9 data. The customer lifetime value however, is not limited to profitability metrics. Other embodiments for a CLV metric as disclosed herein, including corresponding performance and attrition drivers, may be derived for expected product usage, expected contract renewal, and so forth.

In an embodiment, the step of feature selection 118 may include, but is not limited to at least one of removing features with null variability, removing features with near-zero variance, removing highly correlated features, and using machine learning 119 to identify the core features 121 relevant to the customer lifetime value metric. In an embodiment, the core features 121 selected by the steps of feature selection 118 and/or machine learning 119 are provided to the analytics dataset 120, for further input to the CLV framework 130. In an embodiment, the financial product held by the customer is a credit card, the customer lifetime value metric is profit, the performance drivers 122 are credit rating, delinquency rate, interest rate, and yearly spend, and the attrition drivers 123 are customer age, number of years using the credit card, and credit rating.

The step of data and feature engineering 110 selects core features 121, including performance drivers 122 and attrition drivers 123 that are relevant to the desired CLV metric 170. The core features 121 are input to CLV framework 130 for use in determining a CLV metric 170 based on the current performance 140 of the financial product, the future performance 150 of the financial product, and the future behaviour 160 of the customer. In an embodiment, the CLV metric is profitability and accordingly, the performance drivers 122 and attrition drivers 123 are selected based on their relevance to determining profitability. Profitability may represent for example, the amount of interest received by a bank with respect to a financial product held by a customer, such as interest from a credit card, less any losses such as the customer defaulting on credit card payments. In an embodiment, the performance drivers 122 are profit drivers, including at least one of, a total number of product holdings, a banking balance with a financial institution, a banking balance with a plurality of financial institutions, a change in delinquency rate, a change in a financial product interest rate, a change in income; and so forth.

Determining the future performance 150 of the financial product is based on modeling a plurality of customers that use the financial product. The plurality of customers are separated into segments, clusters, or cohorts of customers 154. Each customer cohort is uniquely defined based on one or more core features 121, such as performance driver 122, wherein each customer of the plurality of customers belongs to a single customer cohort. Each customer cohort has a corresponding future performance 156 based on the core features 121 that define the cohort. In an embodiment, the plurality of customer cohorts 154 are defined based on performance driver 122, each cohort of the plurality of cohorts 154 having a corresponding future performance 156 generated based on the corresponding performance driver 122. As such, the future performance 150 includes the set of corresponding future performances 156 generated for each customer cohort. =

In an embodiment, a plurality of customers are segmented into a plurality of customer cohorts based on a clustering algorithm. In an embodiment, the clustering algorithm is a K-means algorithm. Embodiments include implementing the K-means algorithm as a supervised or unsupervised machine learning technique. The K-means algorithms sorts the plurality of customers into cohorts of customers based on a similarity of relationships or characteristics, such as similar performance drivers. The relationship between any two customers may be defined using a distance measure, such as a Euclidean distance. The distance measure may be based on a single performance driver, or a plurality of performance drivers. Pairs of customers having similar performance drivers generate shorter (smaller) distance measures with one-another. In an embodiment, the K-means algorithm segments the plurality of customers into cohorts based on the distance measure. In an embodiment, the distance measure between each pair of customers in a cohort is less than a maximum cohort distance measure. In an embodiment, customers within the same cohort have a corresponding performance driver within three standard deviations of an average of the performance driver for the cohort.

Each corresponding future performance 156 is determined over a period of time. In an embodiment, the corresponding future performances 156 are generated over a remaining lifetime of the financial product. In an embodiment, the remaining lifetime of the financial product is determined using an attrition curve 152, generated using attrition drivers 123 selected during the step of data and feature engineering 110. In an embodiment, the corresponding future performance 156 is a corresponding risk adjusted return, provided as time series data over a remaining lifetime of the financial product, each return generated based on the performance driver 122 that defines the corresponding customer cohort.

Attrition curves, and survival and decay models, such as attrition curve 152, may be used to determine a remaining lifetime of a financial product, for use in determining a future performance 150 of the financial product. For example, an attrition curve may be used to determine how much longer a customer is likely to use a non-term product, such as credit card; or, when a customer may likely default on, or not renew, a term product, such as a mortgage. In an embodiment, the attrition curve 152 is generated using one or more attrition drivers 123. In an embodiment, the attrition drivers 123 include at least one of a risk score, a risk score band, a balanced carried over time, a product usage rate, a delinquency rate, and a default rate. For example, a decrease in the balanced carried over time may be indicative of a customer transitioning away from the corresponding financial product. Similarly, a low product usage over time may be indicative of even less product usage in the future, and eventually no product usage in the future.

In an embodiment, an attrition curve is generated based on historical data indicative of an exit rate at which customers in a cohort have stopped using the financial product. In an embodiment, the exit rate is a number of customers per month that stop using the financial product. In an embodiment, the historical data is based on a previous period of time, wherein the period of time spans at least one year. In an embodiment, the period of time spans at least five years. In an embodiment, the attrition curve is generated based on an average of an attrition driver for each customer in a cohort. For example, customers having a low risk score may be segmented into a cohort of customers having similarly low risk scores, the historical data for which may be indicative of a low exit rate. Whereas, customers having a high risk score may be segmented into a cohort of customers having similarly high risk scores, the historical data for which may be indicative of a high exit rate. The attrition curve can thus be generated based on the historical data to predict a remaining lifetime of the financial product. The attrition curve may be expressed as a decaying curve, wherein at a first point in time the customer participation rate is 100%, decaying over the lifetime of the attrition curve. In an embodiment, the remaining lifetime of the product is a point in time on the attrition curve wherein the participation rate is about 50%. In an embodiment, the remaining lifetime of the product is a point in time on the attrition curve, selected in the range between about a 50% participation rate and about a 60% participation rate.

The future performance 150, and consequently the set of corresponding future performances 156, are adjusted by future behaviour 160, which models the likelihood that a customer will remain in a first customer cohort, or transition to a different customer cohort. In an embodiment, a transition probability matrix 162 models the likelihood that a customer will remain in a given customer cohort, or transition to a different customer cohort. In this manner, future behaviour 160 provides a weighted measure for each corresponding future performance 156. In an embodiment, the future performance 150 includes each corresponding future performance 156 over a remaining lifetime of the financial product, each future performance weighed based on the probability to remain in a current customer cohort, and the probability of transitioning to a different customer cohort. The future performance 150, as modified by future behaviour 160, may be added to the current performance 140 to generate a CLV metric 170.

In an embodiment, the future behaviour is modeled based on historical data indicative of migration patterns between a plurality of customer segments. The historical data may be expressed as a matrix of probabilities over time, for input to a Markov model configured to extrapolate a plurality of transition probability matrices comprising weights for remaining in a given customer cohort, or transitioning to a different customer cohort. In an embodiment, the historical data indicative of migration patterns between a plurality of customer segments is input to a convolutional neural network model that predicts a sequence of migration patterns, for use in generating a plurality of transition probability matrices.

The CLV metric 170 can drive a step of CLV segmentation 180, for assigning a customer to a CLV cohort 182. For example, CLV cohorts 182 may include a plurality of CLV cohorts for customers, such as a first CLV cohort having a high current value and high future value, a second CLV cohort having a low current value and high future value, a third CLV cohort having a high current value and low future value, and a fourth CLV cohort having a low current value and low future value. Such a first CLV cohort may thus be indicative of customers that may need new or increased lines of credit, while such a fourth CLV cohort may be indicative of customers that may need re-engagement, such as new financial products or revised terms on current financial products. Accordingly, The CLV cohorts 182 may inform a final strategy 190, to identify new financial products, terms, and needs that a customer may have.

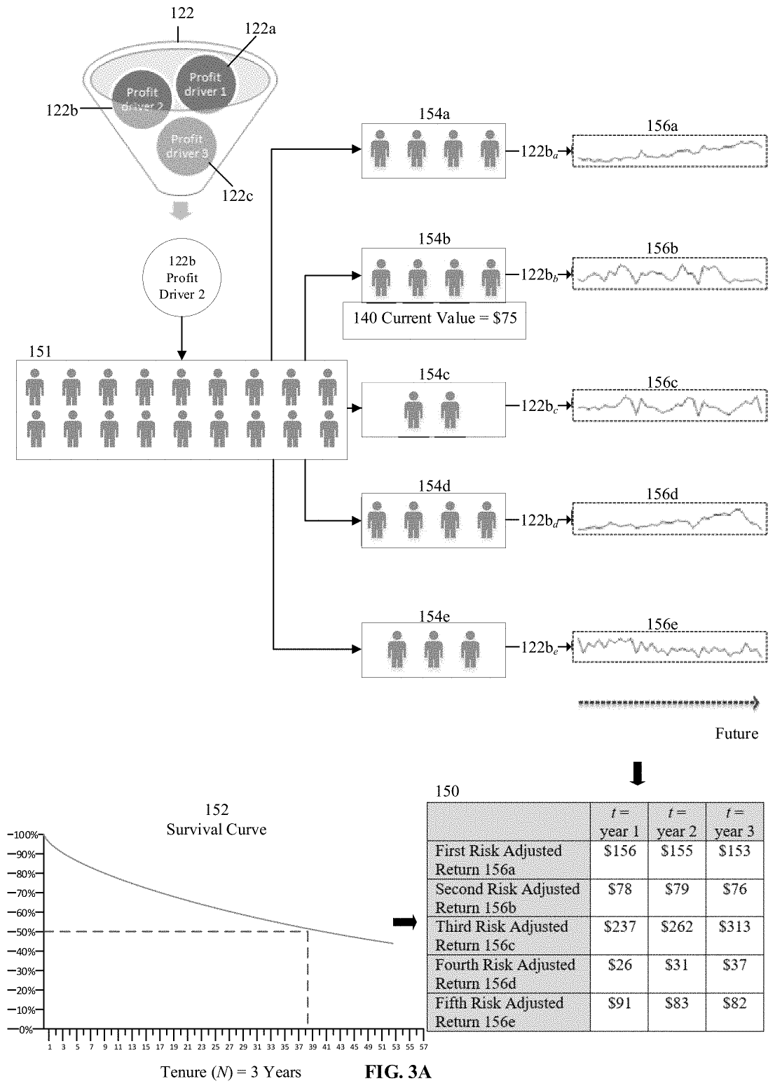

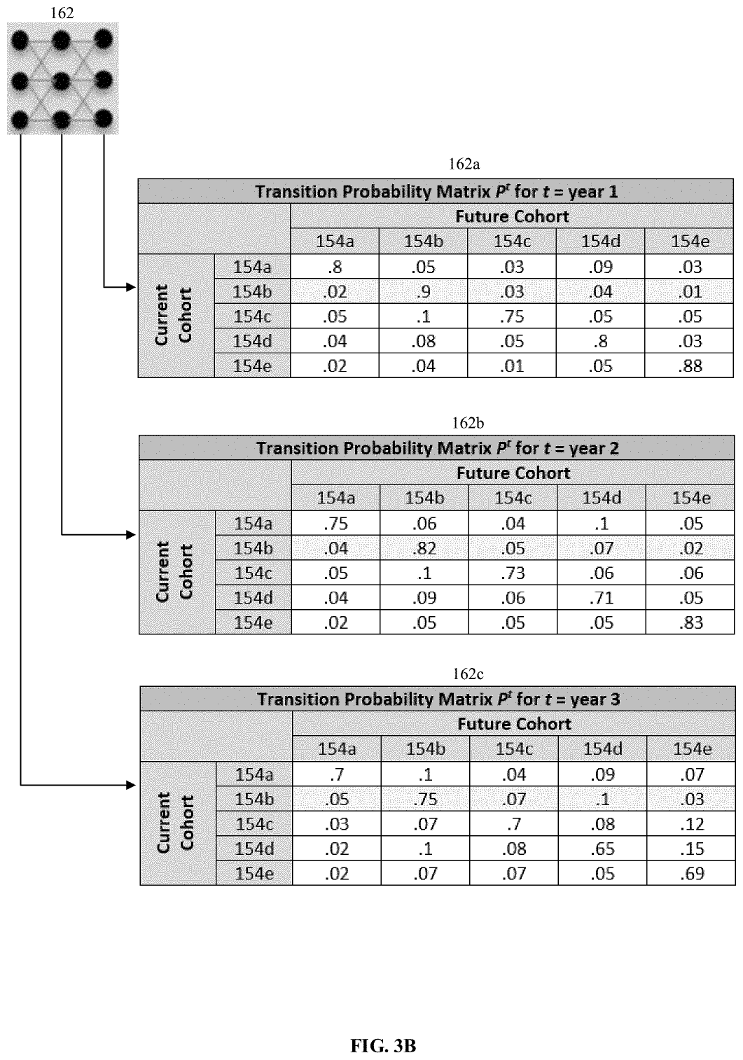

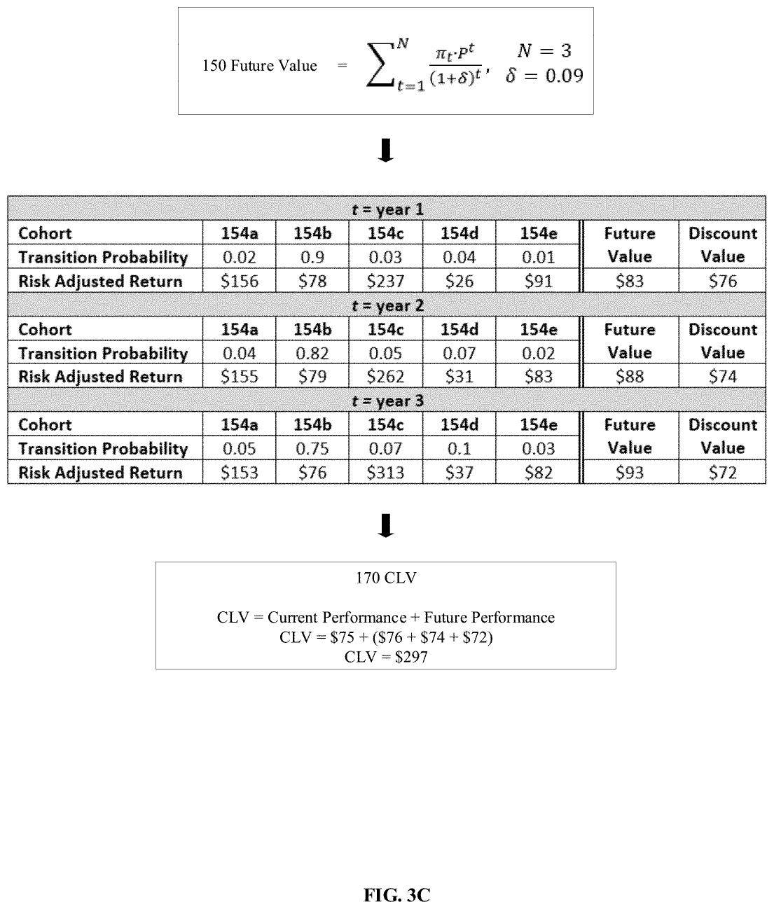

FIGS. 3A, 3B, and 3C illustrate an example of determining a CLV metric 170 in accordance with an embodiment as disclosed herein. In particular, the CLV metric 170 is a profitability metric for a non-term financial product, determined in accordance with equations (1) and (2):

$$\begin{matrix}CLV = Current Performance + Future Performance & ( 1 ) \\ = {\sum }_{t = 0}^{N} \frac{{π}_{t} \cdot {P}^{t}}{{( 1 + δ )}^{{t}^{′}}} & ( 2 )\end{matrix}$$

where:
t is an index for an epoch of time or unit of time, such as days, weeks, months, or years;
N is a remaining lifetime of the financial product;
πₜ is a future performance for a given epoch of time t, such as a risk adjusted return for a given year, where π₁₌₀ is the current performance;
P^{t} is a transition probability matrix for a given epoch of time t, and
δ is a discount rate for estimating future value in present day value.

A performance driver such as a second profit driver 122b, is selected from a plurality of performance drivers 122 to determine a CLV profitability metric 170. A performance driver relates to a feature which drives future performance of a CLV metric, and a CLV metric may be determined for one or more performance drivers. In an embodiment, an analytics dataset 120 or step of data and feature engineering 110 provides the plurality of performance drivers 122, such as a first profit driver 122a, a second profit driver 122b, and a third profit driver 122c. The plurality of performance drivers 122 provide a basis to segment a plurality of customers 151 into unique customer cohorts. As illustrated in FIG. 3A, the second profit drivers 122b segments the plurality of customers 151 into a first customer cohort 154a, second customer cohort 154b, third customer cohort 154c, fourth customer cohort 154d, and fifth customer cohort 154e, where each customer in the plurality of customers 151 belongs to one customer cohort only. Each customer cohort includes customers having similar statistical values of the performance driver. For example, profit driver 122b may relate to credit score and yearly spend, and thereby the plurality of customers 151 are segmented into cohorts with customers having similar credit scores and similar yearly spends. The first profit drivers 122a and third profit drivers 122c may relate to different profit drivers and result in different customer cohorts. Accordingly, the number of cohorts and makeup of each cohort is not fixed and may depend on the performance driver and the statistical value of the performance driver relating to each customer.

While each customer cohort is based on the same performance driver, each customer cohort will have a unique cohort performance driver, representing a statistical value of the performance driver, derived from the customers in the cohort. In an embodiment, a cohort performance driver may represent a mean value, or a medium value of a performance driver for a given customer cohort. As illustrated in FIG. 3A, the first, second, third, fourth, and fifth customer cohorts 154a, 154b, 154c, 154d, and 154e, respectively, have corresponding first, second, third, fourth, and fifth cohort profit drivers 122bₐ, 122b_{b}, 122b_{c}, 122b_{d}, and 122bₑ, respectively, each representing a statistical value of the profit driver 122b, derived from the corresponding customer cohort. As illustrated in FIG. 3A, the first customer cohort 154a has a first cohort profit driver 122bₐ for generating a first future performance 156a. Similarly, each of the second, third, fourth, and fifth customer cohorts 154b, 154c, 154d, and 154e, respectively, have a corresponding second, third, fourth, and fifth profit drivers 122b_{b}, 122b_{c}, 122b_{d}, and 122bₑ respectively, for generating a corresponding second, third, fourth, and fifth future performance 156b, 156c, 156d, and 156e, respectively. Each of the plurality of future performances 156a, 156b, 156c, 156d, and 156e are determined over a remaining lifetime of the financial product. In an embodiment, an attrition curve 152 estimates a remaining lifetime of the financial product. In the illustrative embodiment of FIG. 3A, the plurality of future performances 156a, 156b, 156c, 156d, and 156e are risk adjusted forecasts which account for future profits and losses over a three year period. In an embodiment future losses are determined using expected credit losses as may be derived from international accounting data. In an embodiment, the international accounting data is based on International Financial Reporting Standard 9 (IFRS9).

A future performance 150 may be determined using the plurality of risk adjusted curves 156a, 156b, 156c, 156d, and 156e. The future performance 150 is further adjusted by future behaviour 160, to account for a likelihood that a customer will remain in a given customer cohort, or transition to a different customer cohort. In an embodiment, the future behaviour 160 is modeled using a transition probability matrix 162. In an embodiment, the transition probability matrix 1620 comprises a plurality of transition matrices, such as a first transition probability matrix 162a, a second transition probability matrix 162b, and a third transition probability matrix 162c, each transition probability matrix corresponding to a different epoch of time t. As illustrated in FIG. 3C, the risk adjusted returns are weighed based on a probability to remain in a current customer cohort, or transition to a different customer cohort. In this illustrative example, the CLV metric 170 is determined for a customer in the second customer cohort 154b. In this manner, a future value is generated for each epoch of time t, based on the sum of each of the plurality of risk adjusted returns 156a, 156b, 156c, 156d, and 156e, weighed by the probability of the customer remaining in the second customer cohort 154b and the probability of the customer transitioning to a different customer cohort 154a, 154c, 154d, and 154e. The future value for each epoch of time t is further discounted based on a discount rate δ.

A CLV metric 170 may be determined for a customer in the second cohort 154b in accordance with equation (2), wherein an attrition curve 152 estimates a remaining lifetime N of 3 years, the current value 140_{π}_{₀} is $75, the discount rate is 9%, the future performance π_{t=1 to 3} is provided by the plurality of risk adjusted returns 156a, 156b, 156c, 156d, and 156e, as tabulated in the table of future performance 150, and the probability of remaining in the second cohort 154b or transitioning to a different cohort 154a, 154c, 154d, and 154e, is provided by the transition probability matrices 162a, 162b, and 162c, respectively for each year across the three remaining years of the financial product, as follows:

$${\sum }_{t = 0}^{3} \frac{{π}_{t} \cdot {P}^{t}}{{( 1 + 0.009 )}^{t}}$$

$$t = 0 -> \frac{{π}_{0}}{1} = \$75$$

$$t = 1 -> \frac{{π}_{1} \cdot {P}^{1}}{{( 1 + 0.09 )}^{1}} = \frac{\$156 * 0.02 + \$78 * 0.9 + 237 * 0.03 + \$26 * 0.04 + \$91 * 0.01}{1.09} = \frac{\$83}{1.09} = \$76$$

$$t = 2 -> \frac{{π}_{2} \cdot {P}^{2}}{{( 1 + 0.09 )}^{2}} = \frac{\$155 * 0.04 + \$79 * 0.82 + \$262 * 0.05 + \$31 * 0.07 + \$83 * 0.02}{1.19} = \frac{\$88}{1.19} = \$74$$

$$t = 3 -> \frac{{π}_{3} \cdot {P}^{3}}{{( 1 + 0.09 )}^{3}} = \frac{\$153 * 0.05 + \$76 * 0.75 + \$313 * 0.07 + \$37 * 0.1 + \$82 * 0.03}{1.30} = \frac{\$93}{1.30} = \$72$$

$$CLV = {\sum }_{t = 0}^{N} \frac{{π}_{t} \cdot {P}^{t}}{{( 1 + δ )}^{t}} = \$75 + \$76 + \$74 + \$72 = \$297$$

Accordingly, a customer segmented to the second customer cohort 156b is estimated to provide a CLV profitability metric 170 of $297, over a remaining three year period of the non-term financial product. A CLV profitability metric 170 may be determined for the same customer using a different performance driver, such as profit driver 122a or profit driver 122c, to segment the plurality of customers 151 into a different plurality of customer cohorts, including generating corresponding cohort performance drivers and future cohort performances, and a new transition probability matrix 162. In this manner, a plurality of CLV profitability metrics 170 corresponding to a plurality of profit drivers, may be generated for a given customer. In an embodiment, the financial product is a credit card, line of credit, or savings account, and a CLV profitability metric 170 is generated for at least five different profit drivers. In an embodiment, the CLV profitability metric 170 is the average of all CLV profitability metrics. Determining a CLV profitability metric 170 may also be repeated, for different financial products held by a customer, to generate a total CLV profitability metric 170, across all financial products held by a customer.

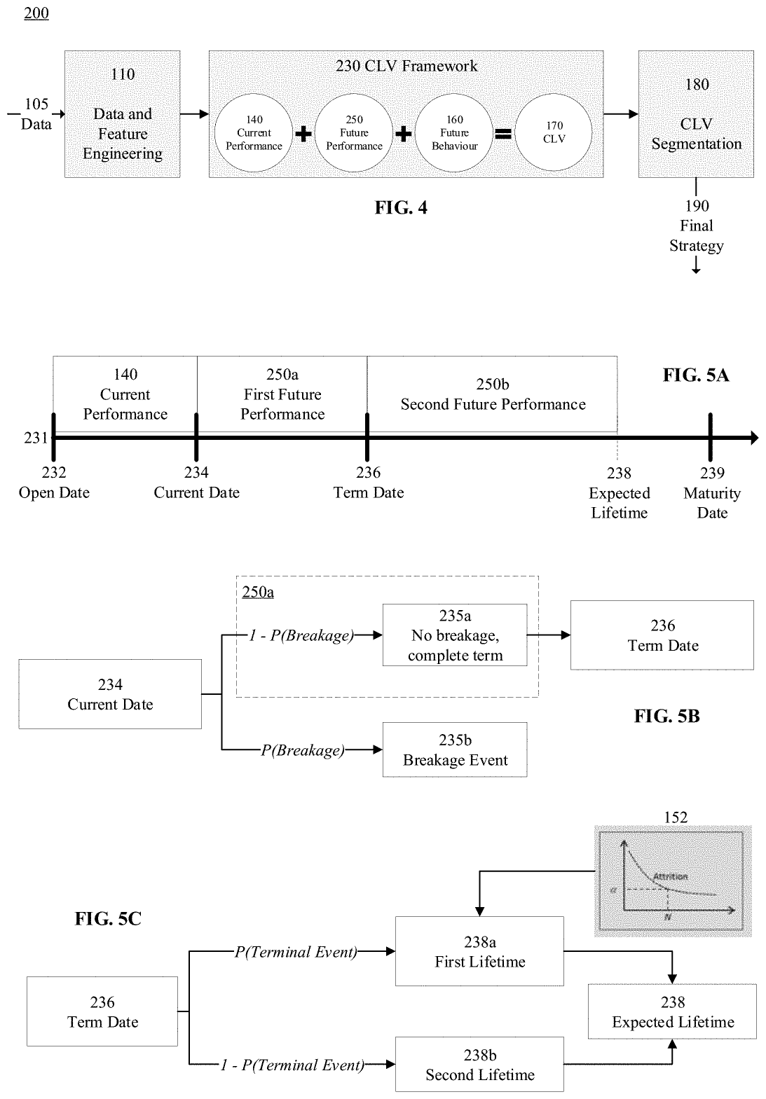

FIG. 4 is an illustrative embodiment of a quantitative customer analysis system and method 200 for a term product as disclosed herein. The system and method 200 features steps as similarly disclosed with respect to the system and method 100, including inputting data 105 to data and feature engineering 110, and a step of CLV segmentation 180 which drives a final strategy 190. The data and feature engineering 110 drive a CLV framework 230 including determining a future performance 250. The future performance 250 for a term product may be determined over an expected lifetime 238 as illustrated in FIG. 5A, based on a first future performance 250a for a remaining term, and a second future performance 250b for an expected lifetime. Term products include but are not limited to mortgages and insurance.

FIG. 5A illustrates a timeline 231 for a term product opened on an opening date 232, and maturing on a maturity date 239. The term product may include a number of renewal dates, such as term date 236 when a customer can renew their term product, re-negotiate their term product, or elect not to renew their term product. As illustrated in FIGS. 5A and 5B, the first future performance 250a is determined over a remaining term between the current date 234 and the term date 236. The system and method 200 disclosed herein includes estimating a probability P(Breakage Event) of a breakage event 235b prematurely concluding the term product prior to the term date 236. Breakage events 235b may include, but are not limited to, a customer default, a charge-off, an early completion of all term obligations, or any other event that terminates the term product. The first future performance 250a is otherwise based on realizing the remaining term value and the probability 1-P(Breakage Event) of no breakage events 235a. The remaining term value is the value of the term product over the remaining term between the current date 234 and the term date 236. For example, the remaining term value for a mortgage may include the remaining net interest income expected between the current date 234 and the term date 236. In an embodiment, the first future performance 250a (abbreviated FP₁) for a term product, is determined in accordance with equation (3):

FP₁=[Remaining Term Value]*[1−P(Breakage Event)] (3)

The second future performance 235b is determined over an expected lifetime 238 of the term product, beginning from the term date 236. The expected lifetime 238 may complete prior to the maturity date 239 as a result of terminal events prematurely concluding the term product. In the absence of a terminal event, the expected lifetime 238 extends to the maturity date 239. Terminal events may include, but are not limited to, a non-renewal of the term product, a customer default, a charge-off, early completion of all term product obligations, or any other event that terminates the term product prior to maturation.

FIG. 5C illustrates a flow chart for determining an expected lifetime 238 in accordance with an embodiment herein. The expected lifetime 238 is calculated beginning from the term date 236. The expected lifetime 238 includes a first lifetime 238a given a terminal event P(Terminal Event), and a second lifetime 238b given no-terminal event 1-P(Terminal Event). The first lifetime 238a may be derived from an attrition curve 152 as disclosed herein. The second lifetime 238b is the remaining time between the term date 236 and the maturity date 239. In an embodiment, the expected lifetime 238, is determined in accordance with equations (4):

E(LT)=P(TE)*E(LT|TE)+[1−P(TE)]*E(LT|NTE) (4)

where:
E(LT) is the expected lifetime;
P(TE) is the probability of a terminal event;
E(LT|TE) is the expected lifetime given a terminal event, and
E(LT|NTE) is the expected lifetime given no terminal event.

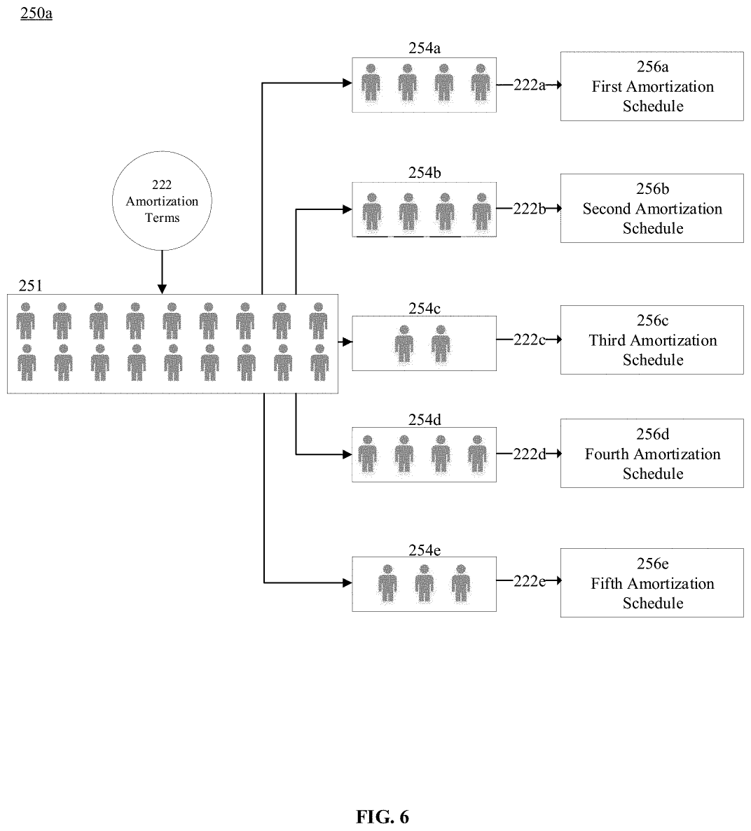

The second future performance 250b is determined over the expected lifetime 238 of the term product, based on amortization schedules, and a transition probability matrix, such as the transition probability matrix 162. As illustrated in the embodiment of FIG. 6, a plurality of customers 251 are segmented into a first, second, third, fourth, and fifth customer cohort 254a, 254b, 254c, 254d, and 254e, respectively, based on amortization terms 222. The amortization terms 222 include data used to calculate an amortization schedule, which may include, a balance, an interest rate, and a remaining lifetime of the term product, such as an expected lifetime 238. The plurality of customers 251 are thus grouped based on the similarity of their term products. Each cohort 254a, 254b, 254c, 254d, and 254e, includes a respective first, second, third, fourth, and fifth cohort amortization driver 222a, 222b, 222c, 222d, and 222e, for use in generating a corresponding amortization schedule 256a, 256b, 256c, 256d, and 256e. The amortization drivers are determined based on a statistical value of the amortization term. For example, the average value of an amortization term for customers segmented in a given cohort may be 4% interest on a $100,000 balance, over an expected lifetime of 4.5 years. Accordingly, the cohort amortization drivers 222a, 222b, 222c, 222d, and 222e, are used to generate respective first, second, third, fourth, and fifth amortization schedules 256a, 256b, 256c, 256d, and 256e, or respective cohorts 254a, 254b, 254c, 254d, and 254e, over the expected lifetime 238 of the term product. In accordance with a future performance 150 as disclosed herein, a second future performance 250a may similarly be determined for a customer, based on the amortization schedules 256a, 256b, 256c, 256d, 256e and the probability of the customer remaining in one amortization cohort, or transitioning to another. The transition probabilities may be derived and represented as a transition probability matrix 162 in accordance with the disclosure herein. The future performance 250 for a term product may thus be determined based on a first future performance 250a over a remaining term and a second future performance 250b over an expected lifetime.

Although the foregoing examples and embodiments disclosed herein have been primarily discussed in the context of future performance and financial institutions, namely commercial banks, the invention is not so limited. A system and method for quantifying customer behaviour as disclosed herein is applicable to numerous industries and metrics without departing from the principles and teachings of the disclosure, industries and metrics including but not limited to, asset management firms and future investment decisions, marketing firms and future sales, and human resources and future promotions, productivity, and remuneration.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof. The scope of the claims should not be limited by the particular embodiments set forth herein, but should be construed in a manner consistent with the specification as a whole.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A computer-implemented method for determining a customer lifetime value (CLV) of a financial product held by a customer, the method comprising:
retrieving, from a memory, an attrition driver and a performance driver;
determining, using a processor, a remaining lifetime of the financial product based on the attrition driver;
determining, using the processor, a plurality of customer cohorts for segmenting a plurality of customers based on the performance driver;
determining, using the processor, a plurality of cohort performance drivers correspondingly based on a value of the performance driver for each cohort of the plurality of customer cohorts;
generating, using the processor, a plurality of risk adjusted forecasts of the financial product over the remaining lifetime of the financial product, correspondingly based on the plurality of cohort performance drivers;
retrieving, from the memory, a transition probability matrix comprising probabilities, over the remaining lifetime of the financial product, for remaining in a current customer cohort or transitioning to a different customer cohort;
determining, using the processor, the CLV over the remaining lifetime of the financial product, the CLV based on a customer current value for the financial product and a weighted sum of the plurality of risk adjusted forecasts and the transition probability matrix.

2. The computer-implemented method of claim 1 further comprising:
generating, using the processor, a plurality of CLV cohorts, each CLV cohort grouped based on current value and future value, and
assigning, using the processor, the customer to one of the plurality of CLV cohorts based on the customer current value and the CLV.

3. The computer implemented method of claim 2 wherein the plurality of CLV cohorts comprises:
a first CLV cohort wherein the current performance is high and the future performance is high;
a second CLV cohort wherein the current performance is low and the future performance is high;
a third CLV cohort wherein the current performance is high and the future performance is low, and
a fourth CLV cohort wherein the current performance is low and the future performance is low.

4. The computer-implemented method of any one of claims 1 to 3 wherein the set of performance drivers for the financial product is generated using machine learning on a plurality of data from a plurality of customers having a history with the financial product.

5. The computer-implemented method of any one of claims 1 to 4 further comprising adjusting the risk adjusted forecast based on a renewal likelihood or a breakage likelihood.

6. The computer-implemented method of any one of claims 1 to 5 wherein the risk adjusted forecast is adjusted based on expected credit loss.

7. The computer-implemented method of claim 6 wherein the expected credit loss is based on external accounting data.

8. The computer-implemented method of claim 7 wherein the external accounting data is based on the International Financial Reporting Standard 9 (IFRS9).

9. The computer-implemented method of any one of claims 1 to 8 further comprising:
generating an attrition curve based on the attrition driver, the attrition curve for determining the remaining lifetime of the financial product.

10. The computer-implemented method of any one of claims 1 to 9 wherein the financial product is at least one of a credit card, a line of credit, or a mortgage.

11. The computer-implemented method of any one of claims 1 to 9 wherein the financial product is a credit card and the set of performance drivers includes a credit score and a delinquency rate.

12. The computer-implemented method of any one of claims 1 to 9 wherein the financial product is a fixed term financial product and the remaining lifetime is a remaining term of the fixed-term financial product.

13. The computer-implemented method of any one of claims 1 to 11 further comprising generating the transition probability matrix using a Markov model.

14. A computer-implemented method for determining a customer lifetime value (CLV) metric for a customer, the method comprising:
segmenting a plurality of customers into a plurality of cohorts based on a performance driver indicative of future customer performance, wherein a first cohort includes the customer;
generating a plurality of cohort forecasts corresponding to the plurality of cohorts, each cohort forecast based on the performance driver of each customer belonging to a corresponding cohort, wherein the plurality of cohort forecasts are generated for a remaining lifetime of the customer, and
calculating the CLV metric based on the plurality of cohort forecasts and a set of transition probabilities indicative of a likelihood that the customer remains in the first cohort, or transitions to a different cohort.

15. The computer-implemented method of claim 14, wherein segmenting the plurality of customers into the plurality of cohorts is based on a similarity metric between the performance driver of each of the plurality of customers.

16. The computer-implemented method of claim 15, wherein the similarity metric is a Euclidean distance.

17. The computer-implemented method of any one of claims 14, wherein the performance driver of each customer of a corresponding cohort is within three-standard deviations of an average value of the performance driver for the corresponding cohort.

18. The computer-implemented method of any one of claims 14 to 17, wherein the remaining lifetime of the customer is based on a remaining lifetime of a cohort.

19. The computer-implemented method of claim 18, wherein the cohort is the first cohort.

20. The computer-implemented method of claim 18 or 19, wherein the remaining lifetime of the cohort is based on an attrition driver for the cohort.

21. The computer-implemented method of claim 20, wherein the attrition driver is at least one of a risk score, a usage rate, a default rate, and a delinquency rate.

22. The computer-implemented method of claim 20, wherein the attrition driver is a customer exit rate based on historical customer data for the cohort.

23. The computer-implemented method of any one of claims 18 to 22, wherein the remaining lifetime is indicative of a point in time wherein 50% of or less of the customers originally in the cohort are no longer expected to remain in one of the plurality of cohorts.

24. The computer-implemented method of any one of claims 14 to 23, wherein the plurality of cohort forecasts are risked adjusted based on a corresponding cohort risk metric.

25. The computer-implemented method of claim 24, wherein the cohort risk metric is indicative of negative future customer performance.

26. The computer-implemented method of any one of claims 14 to 25, wherein the set of transition probabilities is generated based on historical transition data indicative of migration patterns between the plurality of cohorts.

27. The computer-implemented method of claim 26, wherein the set of transition probabilities is generated based on inputting the historical transition data to a Markov model.

28. The computer-implemented method of any one of claims 14 to 28, wherein the CLV metric is a profitability metric for a financial product held by the customer.

29. The computer-implemented method of claim 28, wherein the financial product is a non-term financial product.

30. The computer-implemented method of claim 29, wherein the performance driver is at least one of a balance with a banking institution, an interest rate of the financial product, and a customer income.

31. The computer-implemented method of any one of claims 28 to 30, further comprising applying a discount rate to generate the CLV metric in present day dollars.

32. A computer-implemented method for determining a customer lifetime value (CLV) profitability metric for a plurality of financial products held by a customer using the computer-implemented method of any one of claims 28 to 31.
